(19) United States
(12) Patent Application Publication
(10) Pub. No.: US 2025/0116330 A1
(43) Pub. Date: Apr. 10, 2025

(54) CABLE PULLER

(71) Applicant: MILWAUKEE ELECTRIC TOOL CORPORATION, Brookfield, WI (US)

(72) Inventors: Evan M. Glanzer, Milwaukee, WI (US); Joseph W. Miller, Waukesha, WI (US); Alicia Gayle Rothenberg, Milwaukee, WI (US); Dave M. Rose, Waukesha, WI (US); Garrett P. Mitchell, Milwaukee, WI (US); Kyle S. Lee, Milwaukee, WI (US); Beau A. Harrier, Brown Deer, WI (US)

(21) Appl. No.: 18/909,644

(22) Filed: Oct. 8, 2024

Related U.S. Application Data
(60) Provisional application No. 63/565,759, filed on Mar. 15, 2024.
(60) Provisional application No. 63/589,206, filed on Oct. 10, 2023.

(51) Int. Cl. F16H 61/32; F16H 59/70; F16H 61/28

(52) U.S. Cl. CPC F16H 61/32; F16H 59/70; F16H 61/2807

(57) ABSTRACT

A cable puller has a frame, a capstan rotatably mounted on the frame, a motor which drives the capstan to rotate, a power supply which supplies electrical current to the motor, a transmission which transfers torque from the motor to the capstan, a display mounted to the frame, a sensor operable to generate a signal, and a controller. The transmission can operate in a low-speed configuration and a high-speed configuration. The controller is electrically coupled to the motor, the power supply, and the display. The controller includes computer executable instructions stored in a computer readable medium for controlling operation of the cable puller to receive the signal from the sensor, determine a torque of the capstan based on the signal, determine a tension of a cable being pulled based on the torque of the capstan, and generate a control signal when the tension of the cable approaches a predetermined tension.

### CROSS-REFERENCE TO RELATED APPLICATIONS

This application claims priority to U.S. Provisional Patent Application No. 63/565,759 filed on Mar. 15, 2024 and U.S. Provisional Patent Application No. 63/589,206 filed on Oct. 10, 2023, the entire contents of both of which are incorporated herein by reference.

### FIELD OF THE INVENTION

The disclosure relates to powered construction equipment, and more particularly powered cable pullers.

### BACKGROUND OF THE INVENTION

A cable puller can be used for pulling electrical cable through a conduit in a building from a feeding area to a pulling area, for example. A rope can be attached to an end of the cable and the rope is initially fed through the conduit at the feeding area and wrapped around a capstan of the cable puller in the pulling area, which is rotated to create tension in the rope and pull the cable through the conduit.

### SUMMARY OF THE INVENTION

The disclosure provides, in one aspect, a cable puller comprising a frame, a capstan rotatably mounted on the frame, a motor configured to drive the capstan to rotate, a power supply configured to supply electrical current to the motor, a transmission configured to transfer torque from the motor to the capstan, and a shift assembly. The transmission is configured to operate in a low-speed configuration and a high-speed configuration. The transmission includes a first shaft configured to receive torque from the motor and a second shaft configured to transfer torque to the capstan. The first shaft supports a first low-speed gear, a first high-speed gear, and a shift collar configured to be selectively engaged with the first high-speed gear. The second shaft supports a second low-speed gear meshed with the first low-speed gear and a second high-speed gear meshed with the first high-speed gear. The shift assembly is configured to move the shift collar between a disengaged position and an engaged position. The first low-speed gear and the second low-speed gear have a larger gear ratio than the first high-speed gear and the second high-speed gear. In the low-speed configuration, the shift collar is in the disengaged position. In the high-speed configuration, the shift collar is in the engaged position.

The disclosure provides, in another aspect, a cable pulling system configured to pull a cable through a conduit from a feeding area to a pulling area. The cable pulling system includes a cable puller situated in the pulling area, a first foot pedal situated in the pulling area, a second foot pedal situated in the feeding area, and an adapter. The cable puller has a capstan, a motor configured to drive the capstan to rotate, a power supply configured to supply electrical current to the motor, and a controller. The first foot pedal includes a first transceiver. The second foot pedal includes a second transceiver. The adapter is configured to electrically connect one of the first transceiver and the second transceiver to the conduit. The first transceiver and the second transceiver are configured to send a command to the controller of the cable puller.

The disclosure provides, in another aspect, a method of determining an output force of a cable puller. The cable puller includes a capstan, a motor configured to rotate the capstan to rotate, a transmission configured to transmit torque from the motor to the capstan, a power supply configured to supply electrical current to the motor, and a controller. The method includes determining a power output of the motor, detecting a configuration of the transmission, determining a gear ratio based on the configuration of the transmission, determining a speed of the capstan based on a speed of the motor and the gear ratio, determining a torque of the capstan based on the power output of the motor and the speed of the capstan, and determining the output force of the cable puller using the torque of the capstan and a radius of the capstan.

The disclosure provides, in another aspect, a method of estimating a pull range for a cable puller configured to pull a cable through a conduit. The cable puller includes a capstan, a motor configured to rotate the capstan to rotate, a transmission configured to transmit torque from the motor to the capstan, a battery pack configured to supply electrical current to the motor, and a controller. The method includes measuring a first instantaneous output power of the cable puller; measuring a second instantaneous output power of the cable puller after a predetermined amount of time has elapsed; determining a measured output power increase rate based on the first instantaneous output power, the second instantaneous output power, and the predetermined amount of time; estimating a future power increase rate based on the measured output power increase rate; determining a remaining run time of the cable puller based on a remaining amount of energy of the battery pack and the future power increase rate; and determining a remaining pull range based on the remaining run time and a speed of the capstan

The disclosure provides, in another aspect, a cable puller comprising a frame, a capstan rotatably mounted on the frame, a motor configured to drive the capstan to rotate, a power supply configured to supply electrical current to the motor, a transmission configured to transfer torque from the motor to the capstan, a display mounted to the frame, a sensor operable to generate a signal, and a controller. The transmission is configured to operate in a low-speed configuration and a high-speed configuration. The controller is electrically coupled to the motor, the power supply, and the display. The controller includes a non-transitory computer readable medium and a processor. The controller includes computer executable instructions stored in the computer readable medium for controlling operation of the cable puller to receive the signal from the sensor, determine a torque of the capstan based on the signal, determine a tension of a cable being pulled based on the torque of the capstan, and generate a control signal when the tension of the cable approaches a predetermined tension.

Other features and aspects of the disclosure will become apparent by consideration of the following detailed description and accompanying drawings.

### BRIEF DESCRIPTION OF THE DRAWINGS

### Disclosure

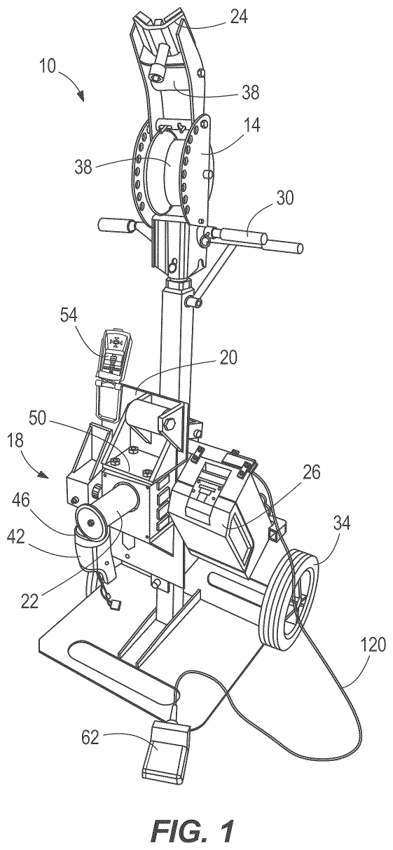

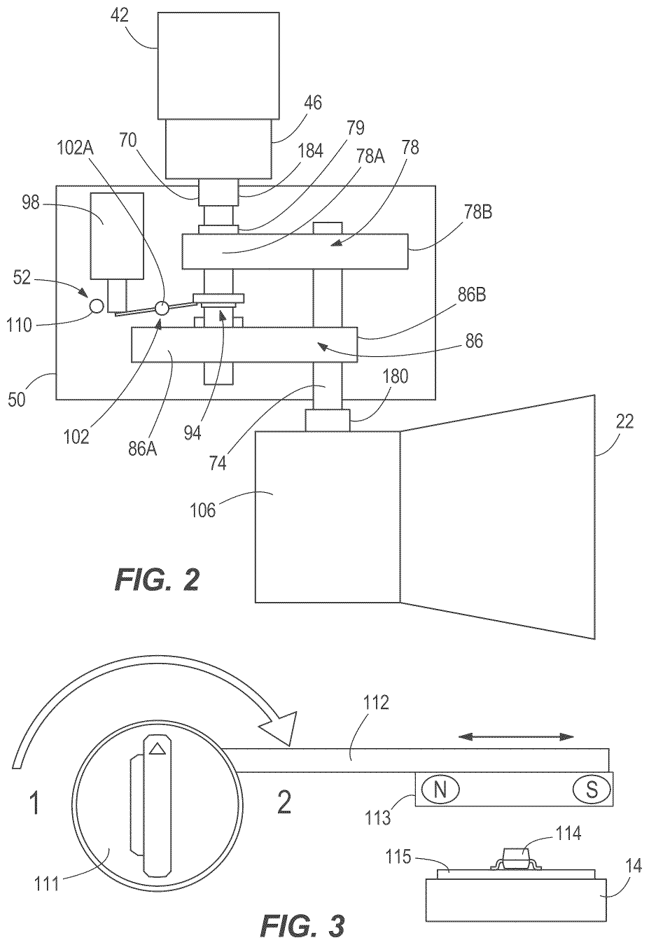

FIG. 1 is a perspective view of a cable puller according to one embodiment of the FIG. 2 is a schematic of a transmission of the cable puller of FIG. 1 according to an embodiment of the disclosure.

FIG. 3 is a diagram of a gear selection interface and gear selection sensor according to an embodiment of the disclosure.

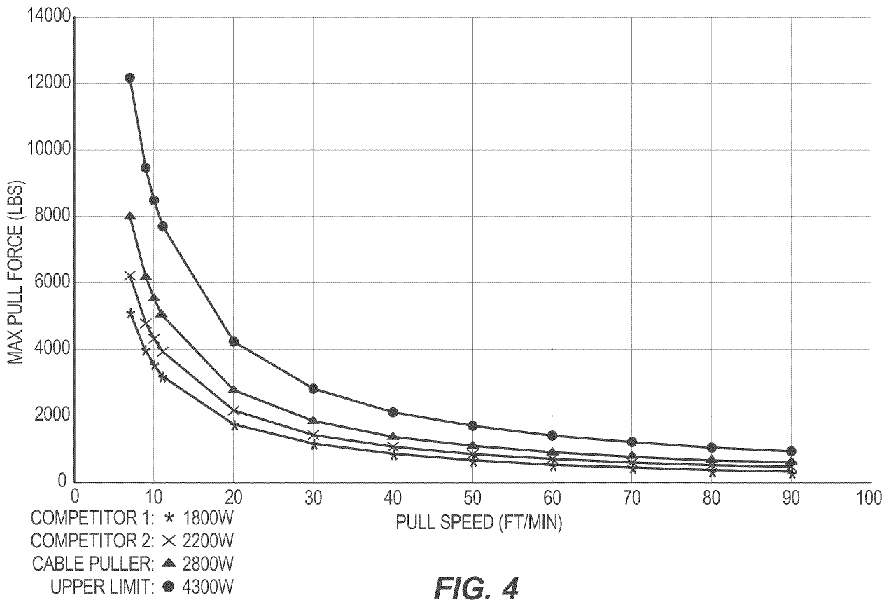

FIG. 4 is a chart comparing the pulling speed and pulling force of the cable puller of FIG. 1 compared to different known cable pullers.

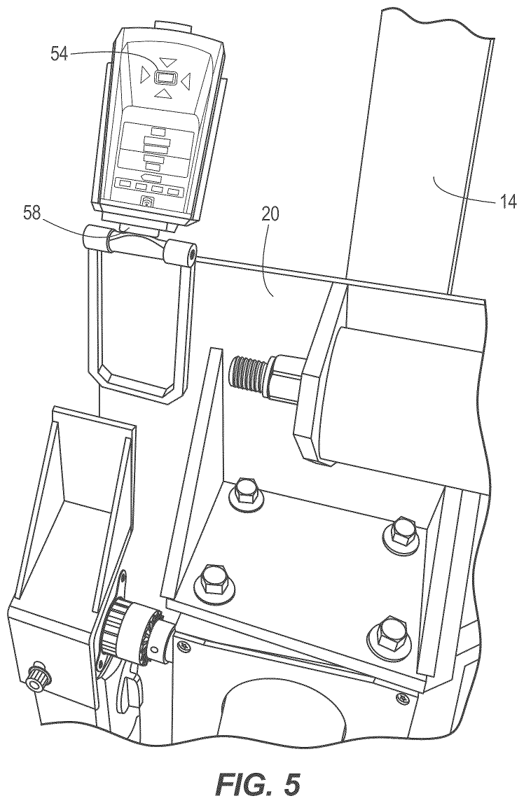

FIG. 5 is a detailed view of a user interface of the cable puller of FIG. 1.

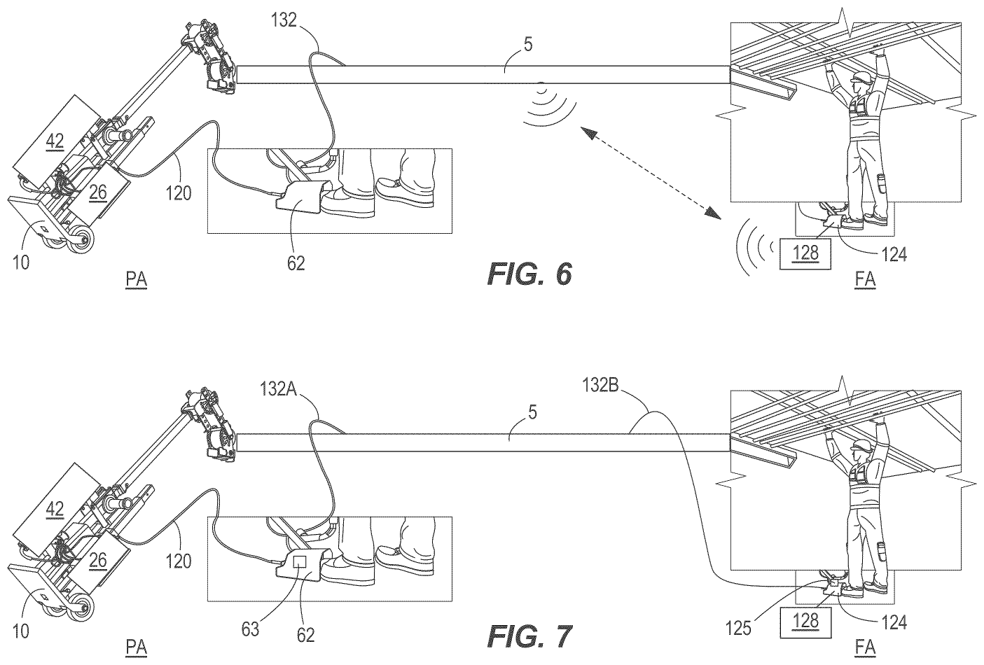

FIG. 6 illustrates a cable pulling system using the cable puller of FIG. 1 according to an embodiment of the disclosure.

FIG. 7 illustrates another cable pulling system using the cable puller of FIG. 1 according to an embodiment of the disclosure.

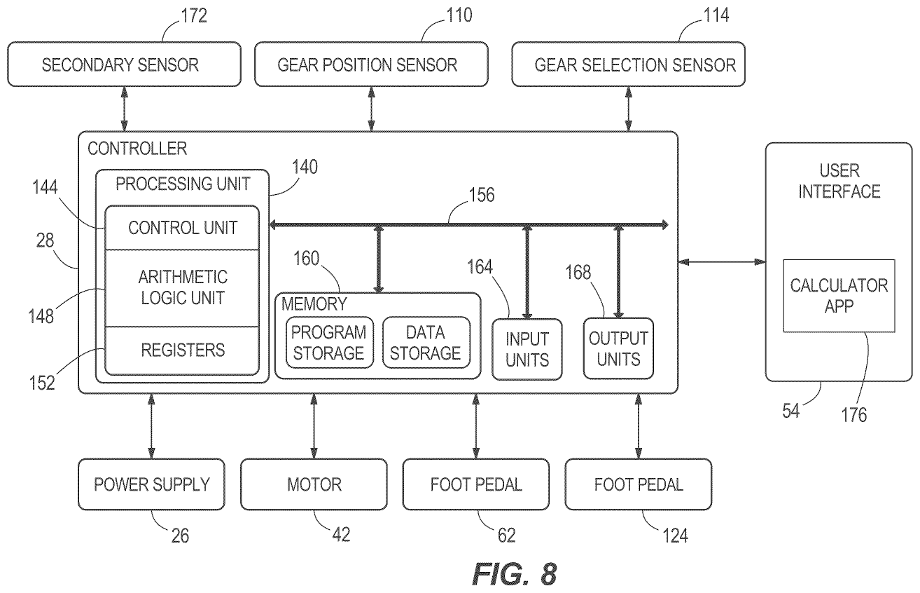

FIG. 8 illustrates a control system for the cable puller of FIG. 1 according to an embodiment of the disclosure.

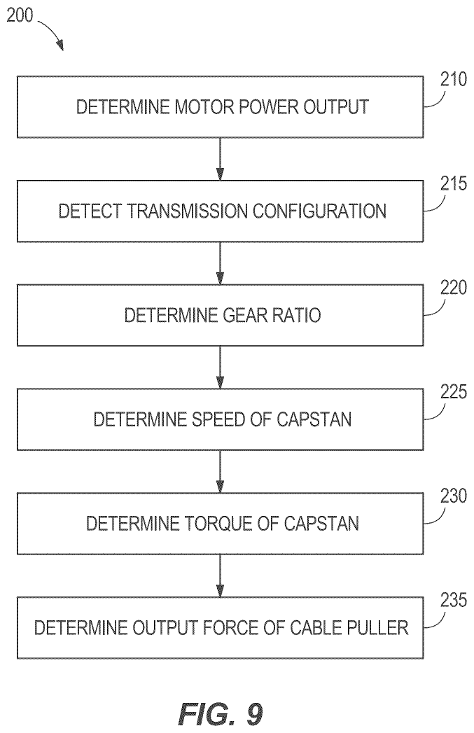

FIG. 9 is a process for determining an output power of the cable puller of FIG. 1.

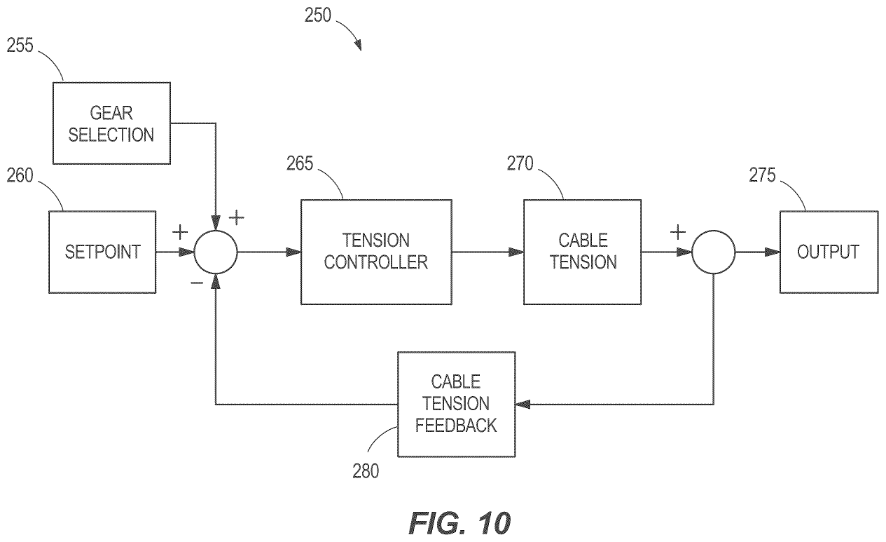

FIG. 10 is a chart showing control of the tool based on pulling force.

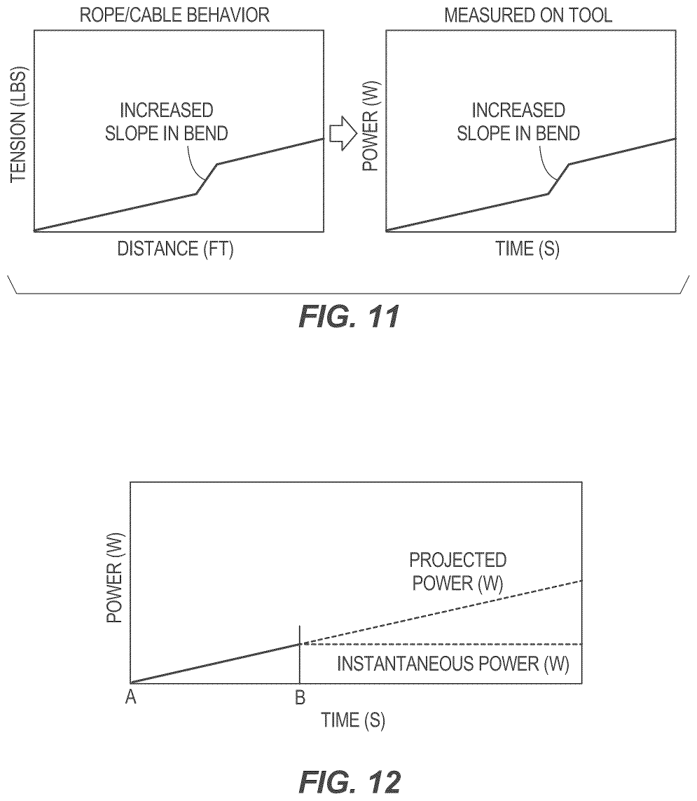

FIG. 11 includes two charts comparing the tension of a cable during a pulling operation and the output power of the cable puller of FIG. 1 during the pulling operation.

FIG. 12 is a chart comparing an instantaneous power of the cable puller and a projected power of the cable puller of FIG. 1.

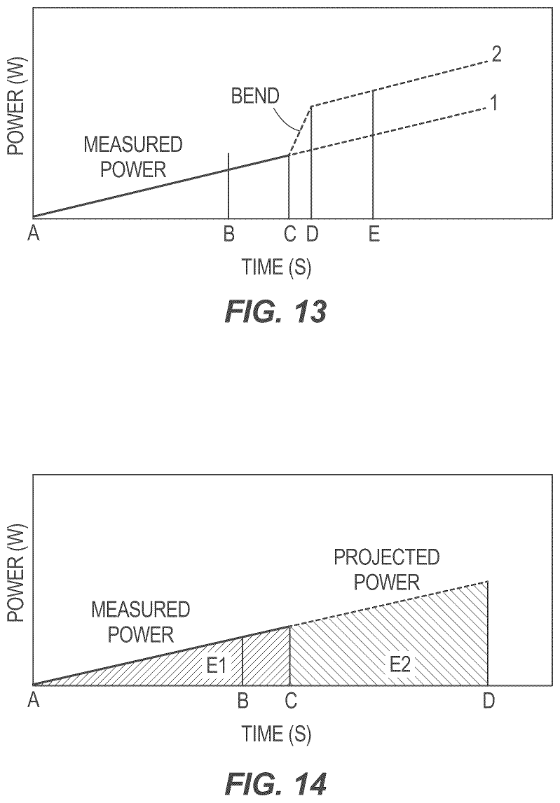

FIG. 13 is a chart showing the effect of a bend in the cable pulling path on the output power of the cable puller of FIG. 1.

FIG. 14 is a chart showing the amount of energy used during a pulling operation.

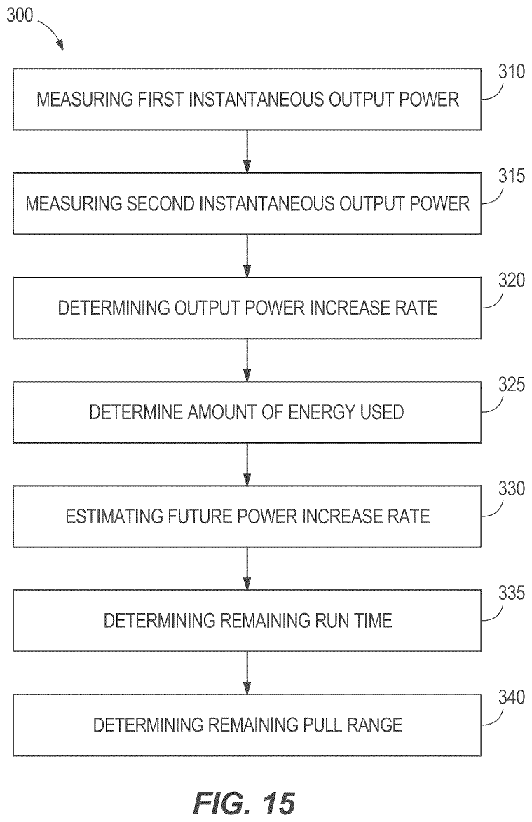

FIG. 15 is a process for determining a pulling range of the cable puller of FIG. 1.

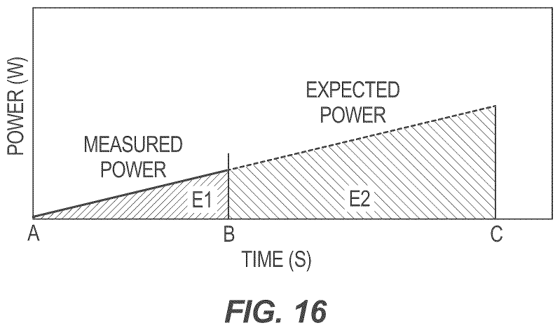

FIG. 16 is another chart showing the amount of energy used during a pulling operation.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

FIG. 1 illustrates a cable puller 10 used for pulling electrical cable through a conduit 5 (FIG. 6) in a building from a feeding area FA (FIG. 6) to a pulling area PA (FIG. 6), for example. As explained in further detail below, rope can be attached to an end of the cable and the rope is initially fed through the conduit 5 at the feeding area FA and wrapped around a capstan 22 of the cable puller 10 in the pulling area PA, which is rotated to create tension in the rope and pull the cable through the conduit 5. After the cable reaches the end of the conduit 5, the rotation of the capstan 22 can be reversed to release the tension in the rope so it can be disconnected from the cable.

The cable puller 10 includes a frame 14, a motor 42, a transmission 18, the capstan 22, a power supply 26, and an electronic control unit or controller 28. The frame 14 supports the components of the cable puller 10. The capstan 22 is rotatably mounted to the frame 14. The frame 14 includes a support plate 20 and a boom 24. Portions of the transmission 18 and power supply 26 may be supported on the support plate 20. The boom 24 may include rollers 38 or idler pulleys that can help guide the rope onto the capstan 22. In the illustrated embodiment, the frame 14 is a portable frame. The frame 14 includes a handle 30 and wheels 34 that allow a user to easily move the cable puller 10. In some embodiments, the cable puller 10 may be mounted to the floor.

The transmission 18 transfers torque from the motor 42 to the capstan 22 to rotate the capstan 22. With reference to FIG. 2, the transmission 18 may include a first gear box 46 (e.g., a fixed gear box) and a second gear box 50 (e.g., an automatic shifting gear box). The first gear box 46 is positioned between the motor 42 and the second gear box 50 and is configured to transfer torque from the motor 42 to the second gear box 50. The first gear box 46 includes an output shaft 70 (e.g., a first shaft) that is configured to receive torque from the motor 42. The first gear box 46 may be a single stage gear box and may include a planetary gear system to increase the torque.

The second gear box 50 is positioned between the first gear box 46 and the capstan 22 and is configured to transfer torque from the first gear box 46 to the capstan 22. The second gear box 50 is a two-speed gear box and is configured to operate in a low-speed (and high-torque) configuration and in a high-speed (low-torque) configuration. The second gear box 50 may include a shift assembly 52 that automatically moves the second gear box 50 between the low-speed configuration and the high-speed configuration.

The second gear box further includes a first gear set 78 (e.g., a low-speed gear set) and a second gear set 86 (e.g., a high-speed gear set). The first gear set 78 has a larger gear ratio than the second gear set 86. The first gear set 78 includes a low-speed pinion 78A (e.g., a first low-speed gear) and a low-speed drive gear 78B (e.g., a second low-speed gear) that are continuously intermeshed. Similarly, the second gear set 86 includes a high-speed drive gear 86A (e.g., a first high-speed gear) and a high-speed pinion 86B (e.g., second high-speed gear) that are continuously intermeshed. The low-speed pinion 78A and the high-speed drive gear 86A are supported on the output shaft 70 of the first gear box 46 which extends into the second gear box 50, while the low-speed drive gear 78B and the high-speed pinion 86B are supported on, and rotationally fixed to, an output shaft 74 (e.g., a second shaft) of the second gear box 50.

The low-speed pinion 78A is supported on the output shaft 70 by an overrunning clutch 79. At low speeds, the low-speed pinion 78A is rotationally fixed to the output shaft 70 via the overrunning clutch 79 and transfers torque from the output shaft 70 to the low-speed drive gear 78B to drive the output shaft 74 to rotate at a low speed. The overrunning clutch 79 is configured to disengage the low-speed pinion 78A from the output shaft 70 when the rotational speed of the output shaft 70 exceeds a predetermined limit. At high speeds, the output shaft 70 rotates relative to the low-speed pinion 78A such that torque cannot be transferred from the output shaft 70 to the low-speed pinion 78A.

The high-speed drive gear 86A is loosely supported on the output shaft 70. A shift collar 94 supported on the output shaft 70 is configured to selectively engage the high-speed drive gear 86A and rotationally fix the high-speed drive gear 86A to the output shaft 70. The shift collar 94 is disengaged from the high-speed drive gear 86A in the low-speed configuration. When the shift collar 94 is disengaged from the high-speed drive gear 86A, the output shaft 70 rotates relative to the high-speed drive gear 86A such that torque is not transferred between the output shaft 70 to the high-speed drive gear 86A. When the shift collar 94 is engaged with the high-speed drive gear 86A, the high-speed drive gear 86A is rotationally fixed to the output shaft 70 and is driven to rotate. The high-speed drive gear 86A transfers torque from the output shaft 70 to the high-speed pinion 86B to drive the output shaft 74 to rotate at a high speed.

The shift assembly 52 is operable to move the shift collar 94 between an engaged position and a disengaged position. The shift assembly 52 includes a shift actuator 98 having an output plunger and a lever 102 having one end coupled to the output plunger of the shift actuator 98 and another end coupled to the shift collar 94. The lever 102 pivots about a pivot point 102A. The shift actuator 98 may be an electromagnetic solenoid. When the shift actuator 98 is activated, it pivots the lever 102 which moves the shift collar 94 along the output shaft 70 between the engaged and disengaged position. The shift actuator 98 may be activated by a control signal from the controller 28 when a higher capstan speed is desired or when a lower capstan speed is desired.

In the low-speed configuration, torque is transferred from the motor 42 to the low-speed pinion 78A via the output shaft 70 and transferred from the low-speed pinion 78A to the low-speed drive gear 78B to drive the output shaft 74 to rotate at a low speed. The low-speed pinion 78A is rotationally fixed to the output shaft 70 by the overrunning clutch 79, and the shift collar 94 is in the disengaged position such that the high-speed drive gear 86A is loosely coupled to the output shaft 70. The output shaft 70 does not transfer torque to the high-speed drive gear 86A.

In the high-speed configuration, torque is transferred from the motor 42 to the high-speed drive gear 86A via the output shaft 70 and transferred from the high-speed drive gear 86A to the high-speed pinion 86B to drive the output shaft 74 to rotate at a high speed. The overrunning clutch 79 disengaged the low-speed pinion 78A from the output shaft 70, and the shift collar 94 is in the engaged position such that the high-speed drive gear 86A is rotationally fixed to the output shaft 70. The output shaft 70 does not transfer torque to the low-speed pinion 78A.

With continued reference to FIG. 2, the transmission 18 may further include a single stage worm gear 106 positioned between the output shaft 74 of the second gear box 50 and the capstan 22 such that torque is transferred from the output shaft 74 to the capstan 22 via the single stage worm gear 106. The single stage worm gear 106 prevents the capstan 22 from being back driven. In some embodiments, the single stage worm gear 106 may be replaced with a mechanical brake.

The transmission 18 may also include a gear position sensor 110 that is configured to detect if the transmission 18 is in the low-speed configuration or in the high-speed configuration. The gear position sensor 110 may be a Hall-effect sensor that can detect the presence of a magnet positioned on the shift collar 94. The gear position sensor 110 may generate a negative signal when the shift collar 94 is in the disengaged position, indicating that transmission 18 is in the low-speed configuration. The gear position sensor 110 may generate a positive signal when the shift collar 94 is in the engaged position, indicating that the transmission 18 is in the high-speed configuration.

With reference to FIG. 3, rather than detecting the position of one of the components of the transmission 18 like the shift collar 94, the cable puller may alternatively include a gear selection interface 111 (e.g., a rotatable dial) and an arm 112 coupled to the gear selection interface 111 and that supports one or more magnets 113 (e.g., one magnet having spaced North and South poles) positioned in proximity to a gear selection sensor 114 (e.g., a Hall-effect sensor) supported on a printed circuit board 115 coupled to the cable puller, for instance, to the frame 14, or in other embodiments, the second gear box 50, or another area of the cable puller 10. The gear selection interface 111 is rotatable between first and second positions, as indicated in FIG. 3, to shift the transmission 18 between the low-speed configuration and the high-speed configuration. The first position may correspond to the low-speed configuration and the second position to high-speed configuration, or vice versa. Rotation of the gear selection interface 111, in addition to shifting the transmission 18, translates the arm 112 and magnet 113 along a linear path adjacent the gear selection sensor 114. As the magnet 113 is translated by rotation of the gear selection interface 111, the gear selection sensor 114 provides an output signal indicative of the position of the magnet 113, and therefore, the gear selection interface 111. The signal from the gear selection sensor 114 is provided to the controller 28 and is used by the controller 28 to determine the operation mode of the cable puller 10.

Turning back to FIG. 1, the power supply 26 supplies electrical current to the motor 42. In the illustrated embodiment, the power supply 26 is a rechargeable battery pack. The features of the power supply 26, the motor 42, and accompanying electronics and controls of the power supply 26 are further described in U.S. patent application Ser. No. 16/025,491 filed on Jul. 2, 2018, also U.S. Pat. No. 11,652,437 granted on May 16, 2023, the entire content of which is incorporated by reference herein. The features of the power supply 26, the motor 42, and accompanying electronic and controls of the power supply 26 are also further described in U.S. patent application Ser. No. 18/317,317 filed on May 15, 2023, also U.S. Patent Application Publication No. 2023/0283221 filed on Sep. 7, 2023, the entire content of which is incorporated by reference herein.

With reference to FIG. 4, the motor 42 and the power supply 26 allow the cable puller 10 to have a higher amount of pulling force and power output, compared to other cable pullers. A first competitor cable puller has a power supply with a maximum power output of 1800 W and has a maximum pulling force that is below 6000 lbs. A second competitor cable puller has a power supply with a maximum power output of 2200 W and has a maximum pulling force that is near 6000 lbs. In one embodiment of the cable puller 10, the power supply 26 has a maximum power output of 2800 W, and the cable puller 10 has maximum pulling force of 8000 lbs. In another embodiment of the cable puller 10, the power supply 26 has a maximum power output of 4300 W, and the cable puller 10 has a maximum pulling force above 12,000 lbs.

The motor 42 and the power supply 26 also allow the cable puller 10 to maintain a high amount of pulling power throughout the pulling process. As shown above, known competitor cable pullers have power supplies with smaller power outputs. The smaller power outputs limit the maximum continuous power of the cable puller. For example, the second competitor cable puller cannot continuously apply 6000 lbs of pulling force. Instead, the second competitor cable puller may apply 4000 lbs of pulling force with a peak of 6000 lbs. In some cable pullers, the cable puller may have a limited duty cycle that moves the pulling force between 4000 lbs and 5000 lbs with a peak of 6000 lbs. The power supply 26 has a higher power output such that the cable puller 10 can continuously pull at higher forces and higher speeds.

Turning to FIG. 5, the cable puller 10 may also include a display or user interface 54. The user interface 54 may show the user information about the cable or rope tension, the rotational speed of the capstan 22, and the length of the cable pulled. The user interface 54 may determine the tension of the cable based on the amount of electrical current drawn by the motor 42. The user interface 54 may include a series of LEDs that are illuminated as the electrical current drawn by the motor 42 increases (thus permitting the motor 42 to output more torque). The LEDs allow the user to determine if the pulling operation is progressing normally or if an abnormality is detected. In a normal pulling operation, the LEDs would show the electrical current drawn by the motor 42 slowly increasing. If an abnormality is detected (e.g., the cable becomes stuck in the conduit), the LEDs would indicate a spike in the electrical current drawn by the motor 42. In other embodiments, the user interface 54 may include a numerical estimate of the tension in the rope to which the cable is attached (and thus the cable itself) or a rotating dial that shows the tension in the cable.

The user interface 54 is attached to a mount 58. The mount 58 may have a swiveling base that allows the user interface 54 to rotate to an optimal viewing angle during a pulling operation. The mount 58 may also have a magnetic base that allows the display to be mounted on different locations of the frame 14. In the illustrated embodiment, the user interface 54 and mount 58 are mounted to the support plate 20, but the user interface 54 and mount 58 can be moved to be mounted on the boom 24. In the illustrated embodiment, the user interface 54 is wired to the electronics of the cable puller 10. In other embodiments, the user interface 54 may be wirelessly attached to the electronics of the cable puller 10.

With reference to FIGS. 1 and 5-6, the cable puller 10 may also include a foot pedal 62. The foot pedal 62 controls the on/off function of the cable puller 10. The foot pedal 62 may also include a separate switch that can be used to switch the rotation direction of the capstan 22. The foot pedal 62 allows a user to change the rotational direction of the capstan 22 to release tension in the cable while maintaining a safe distance from the cable puller 10. The tension in the cable may need to be released when the rope to which the cable is attached becomes tangled or wraps on top of itself. In other cable pullers, the rotation switch is located on the frame 14 of the cable puller 10 such that the user must be near the cable that is under tension to reverse the capstan 22 and release the tension in the rope. In the illustrated embodiment, the foot pedal 62 is connected to the cable puller 10 by a wire 120. In some embodiments, the foot pedal 62 may be wirelessly connected to the cable puller 10.

With continued reference to FIG. 6, in some cable pulling operations, the cable pulling system may include the cable puller 10 situated in the pulling area PA, the foot pedal 62 (e.g., a first foot pedal) situated in the pulling area PA, a second foot pedal 124 situated in the cable feeding area FA, and a metal conduit 5 extending between the pulling area PA and the feeding area FA. The second foot pedal 124 allows a user at the feeding area FA to communicate with the cable puller 10 or a user in the pulling area PA if there is an issue at the feeding area FA or if the cable has been completely fed into the conduit 5. In the illustrated embodiment, a battery pack 128 supplies power to the second pedal 124.

The first foot pedal 62 includes a first transceiver 63 and the second foot pedal 124 includes a second transceiver 125. The transceivers 63, 125 can send control signals (e.g., commands) to the other transceiver and to the controller 28 of the cable puller 10 and can receive control signals from the other transceiver and from the controller 28. The control signals sent to the controller 28 may start or stop the operation of the cable puller 10 or change the rotational direction of the capstan 22. The transceivers 63, 125 may be a wireless transceiver or an RF transceiver. In other cable pulling systems, both foot pedals 62, 124 may send the control signals via radio waves or wirelessly to each other and to the controller 28. Frequently, however, the feeding area FA may be out of range from the cable pulling area PA or there may be obstructions (e.g., bends, walls) that interrupt the signals being sent from the transceivers 63, 125. Some cable pulling systems have added a fixed antenna to one, or both, of the foot pedals to increase the range of the foot pedals. However, the fixed antenna may only marginally increase the range of the foot pedals. To further increase the range of the foot pedals 62, 124, the cable pulling system may include an adapter 132 which electrically connects the transceiver of 63, 125 one of the foot pedals 62, 124 and the conduit 5. In the illustrated embodiment, the adapter 132 is connected to the first transceiver 63 of the first foot pedal 62. The adapter 132 may be a flexible electrical cable such as a coaxial cable that plugs into the foot pedal 62 and contacts a side surface of the conduit 5. By connecting the transceiver 63 to the conduit 5 with the adapter 132, the conduit 5 behaves as an elongated antenna for the connected foot pedal 62. Having the conduit 5 act like an elongated antenna increases the range of the connected foot pedal 62 which allows for longer distances between the cable pulling area PA and the feeding area FA. The signals travel from the first transceiver 63 of the first foot pedal 62, along the conduit 5, and are wirelessly transmitted to the second foot pedal 124. In some embodiments, the adapter 132 may be connected to the second transceiver 125 of the second foot pedal 124 instead of the first foot pedal 62. In some embodiments, the adapter 132 may be connected to the cable puller 10.

In some embodiments, as shown in FIG. 7, a first adapter 132A connects the first transceiver 63 of the first foot pedal 62 to the conduit 5 and a second adapter 132B connects the second transceiver 125 of the second foot pedal 124 to the conduit 5. In this embodiment, the first foot pedal 62 and the second foot pedal 124 send signals through the conduit 5 and do not need an additional wireless signal.

Turning to FIG. 8, the controller 28 is provided for controlling the operation of the cable puller 10 (FIG. 1). The controller 28 is electrically and/or communicatively connected to a variety of modules or components of the cable puller 10. For example, the illustrated controller 28 may be connected to the power supply 26, the motor 42, the first foot pedal 62, the second foot pedal 124, the gear position sensor 110, gear selection sensor 114, one or more secondary sensors 172 (e.g., temperature sensors, timers), and user interface module 54. The controller 28 includes combinations of hardware and software that are operable to, among other things, control the operation of the cable puller 10, control the user interface 54, monitor the operation of the cable puller 10, etc.

In some embodiments, the controller 28 includes a plurality of electrical and electronic components that provide power, operational control, and protection to the components and modules within the controller 28 and/or the cable puller 10. For example, the controller 28 includes, among other things, a processing unit 140 (e.g., a microprocessor, a microcontroller, or another suitable programmable device), a memory 160, input units 164, and output units 168. The processing unit 140 includes, among other things, a control unit 144, an arithmetic logic unit (“ALU”) 148, and a plurality of registers 152 (shown as a group of registers in FIG. 8), and is implemented using a known computer architecture, such as a modified Harvard architecture, a von Neumann architecture, etc. The processing unit 140, the memory 160, the input units 164, and the output units 168 as well as the various modules connected to the controller 28 are connected by one or more control and/or data buses (e.g., common bus 156). The control and/or data buses are shown generally in FIG. 8 for illustrative purposes. The use of one or more control and/or data buses for the interconnection between and communication among the various modules and components would be known to a person skilled in the art in view of the embodiments described herein.

The memory 160 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, electronic memory devices, or other data structures. The processing unit 140 is connected to the memory 160 and executes software instructions that are capable of being stored in a RAM of the memory 160 (e.g., during execution), a ROM of the memory 160 (e.g., on a generally permanent basis), or another non-transitory computer readable medium such as another memory or a disc. Software included in the implementation of the cable puller 10 can be stored in the memory 160. The software includes, for example, firmware, one or more applications, program data, filters, rules, one or more program modules, and other executable instructions. The controller 28 is configured to retrieve from memory and execute, among other things, instructions related to the control processes and methods described herein. In other embodiments, the controller 28 may include additional, fewer, or different components.

The controller 28 may be operable to, among other things, send and receive control signals to/from the motor 42, the power supply 26, the user interface 54, and the foot pedals 62, 124; receive signals from the gear position sensor 110, gear selection sensor 114 and the secondary sensors 172; determine a torque of the capstan 22; determine the tension of the cable during a pull operation based off of the torque; generate a control signal when the tension of the cable exceeds a predetermined tension; and determine a pull range of the cable puller 10 based on the power supply 26;

FIG. 9 is a process 200 for determining the output force of the cable puller 10 during a pulling operation. The output force corresponds to the tension of the cable being pulled. The process begins with the controller 28 determining the power output of the motor 42 (STEP 210) based on the voltage and electrical current drawn by the motor 42. The motor power output, Power_{M}, can be calculated as set forth below in EQN 1:

$${Power}_{M} = C u r r e n {t}_{M} \times {Voltage}_{M} \qquad EQN . 1$$

where Current_{M} is the instantaneous current of the motor 42 and Voltage_{M} is the instantaneous voltage of the motor 42. The instantaneous current, Current_{M}, may be determined with sense resistors placed in the motor drive electronics. The instantaneous voltage, Voltage_{M}, may be determined by a voltage divider placed in the motor drive electronics. In some embodiments, the motor power output, Power_{M}, may also be based on the efficiency of the motor.

Then, the controller 28 determines the configuration of the transmission 18 (STEP 215). More specifically, the controller 28 determines if the transmission 18 is in the low-speed configuration or in the high-speed configuration. The controller 28 receives a signal from the gear position sensor 110 positioned in the second gear box 50. The gear position sensor 110 may send a positive signal when the shift collar 94 is engaged with the high-speed drive gear 86A to indicate that the transmission 18 is in the high-speed configuration. The gear position sensor 110 may send a negative signal when the shift collar 94 is disengaged from the high-speed drive gear 86A to indicate that the transmission 18 is in the low-speed configuration.

In another embodiment, the controller 28 receives a signal from the gear selection sensor 114. The gear selection sensor 114 may send a positive signal when the gear selection interface 111 is in a position indicating the transmission 18 has been shifted to the high-speed configuration and a negative signal when the gear selection interface 111 is in a position indicating the transmission 18 has been shifted to the low-speed configuration. The gear selection sensor 114 may instead send a positive signal indicating the low-speed configuration and a negative signal indicating the high speed configuration.

Once the transmission configuration is determined, the controller 28 determines the gear ratio of the transmission 18 (STEP 220) based on the transmission configuration. The gear ratio values are constants stored in the memory 160 that are specific to the transmission 18.

At STEP 225, the controller 28 determines the speed of the capstan 22. The capstan speed, Speed_{C}, is based on the speed of the motor 42 and the determined gear ratio. The motor speed may be determined with Hall-effect sensors placed in the motor 42. Then, the torque of the capstan 22 is determined (STEP 230). The capstan torque is based on the motor power output, Power_{M}, and the capstan speed, Speed_{C}. The capstan torque, Torque_{C}, can be calculated as set forth below in EQN 2.

$${Torque}_{C} = P o w e {r}_{M} / Spee {d}_{C} \qquad EQN . 2$$

Next, the controller 28 determines the output force of the cable puller 10 (STEP 235) based on the capstan torque, Torque_{C} and the radius of the capstan 22. The cable puller output force, Force_{C}, can be calculated as set forth below in EQN 3:

$${Force}_{C} = {Torque}_{C} \times 2 π \times {Radius}_{C} \qquad EQN . 3$$

where Radius_{C} is a constant stored in the memory 160 that is specific to the capstan 22.

Although the process 200 of determining the cable puller output force, Force_{C}, is described in sequential steps, it will be appreciated that some of the steps may be completed in a different order, some of the steps may be completed simultaneously, and some of the steps may be omitted.

As shown in FIG. 11, the cable puller output force, Force_{C}, corresponds to the tension in the rope during the pulling operation. The cable puller output force, Force_{C}, may be an overestimate of the tension in the rope because it does not account for rope slippage on the capstan 22. The controller 28 may use machine learning to better train the controller 28 such that the tension of the rope is a more accurate measurement. The process 200 may be completed multiple times throughout the entire pulling operation such that the cable puller output force, Force_{C}, and the tension in the rope is constantly being determined throughout the entire pulling operation.

In another embodiment, the cable puller output force, Force_{C}, may be determined with an electronic clutch 180 (FIG. 2). The features of the electronic clutch 180 are further described in U.S. patent application Ser. No. 15/146,547 filed on May 4, 2016, also U.S. Pat. No. 10,850,380 granted on Dec. 1, 2020, the entire content of which is incorporated by reference herein. The electronic clutch 180 may be coupled to the output shaft 74 of the second gear box 50. The electronic clutch 180 may include sensors that allow the electronic clutch 180 to determine the capstan speed, Speed_{C}. After the capstan speed, Speed_{C}, is determined, STEPS 230-235 of the process 200 can be completed to determine the cable puller output force, Force_{C}. The second gear box 50 may include secondary sensors 172 such as temperature sensors that measure the temperature of the second gear box 50. In some embodiments, the cable puller output force, Force_{C}, may additionally depend on the measured temperature. The process of using the electronic clutch 180 and the temperature sensors to determine the cable puller output force, Force_{C}, may have an accuracy of 5%.

In yet another embodiment, the cable puller output force, Force_{C}, may be determined with a torque transducer 184 (FIG. 2) coupled to the output shaft 70 of the first gear box 46. The torque transducer 184 may measure the torque of the motor 42. The capstan torque, Torque_{C}, can be determined using the torque of the motor 42 and the gear ratio (STEP 220). After the capstan torque, Torque_{C}, is determined, STEP 235 of the process 200 can be completed to determine the cable puller output force, Force_{C}. The second gear box 50 may include secondary sensors 172 such as temperature sensors that measure the temperature of the second gear box 50. In some embodiments, the cable puller output force, Force_{C}, may additionally depend on the measured temperature. The process of using the torque transducer 184 and the temperature sensors to determine the cable puller output force, Force_{C}, may have an accuracy of 0.5%.

After the cable puller output force, Force_{C}, is determined, it may be stored in a data log in the memory 160 of the cable puller 10. The data log may be accessed by a user at a later time through the user interface 54. The cable puller output force, Force_{C}, may also be displayed on the user interface 54 in real time.

The cable puller 10 may also compare the measured cable puller output force, Force_{C}, with a predetermined maximum force level. The predetermined maximum force level may be a constant value stored in the memory 160 that is specific to the type of rope or cable being pulled, may be based on a user input, or may be determined with the pull calculator app module 176 in the user interface 54. The pull calculator app 176 allows a user to plan the pulling operation and determine an expected tension during the pulling operation. The excepted tension is based on the conduit and the rope being pulled. The user provides information about each section of the conduit (e.g., length of segment, bend locations, bend angles) and the size and type of rope being pulled. The expected tension can be used as the predetermined maximum force level and can be used to ensure that the expected tension will not exceed the rated strength of the rope or cable. In the illustrated embodiment, the pull calculator app 176 is integrated with the user interface 54. In some embodiments, the pull calculator app 176 may be a separate device (e.g., an application for a smart phone) and can wirelessly communicate with the controller 28.

During the pulling operation, if the controller 28 determines that the cable puller output force, Force_{C}, is approaching the predetermined maximum force level or if the predetermined maximum force level is met, the controller 28 may generate a control signal. The control signal may be operable to prompt the controller 28 to display a warning message on the user interface 54. The warning message may be a plurality of LED lights that illuminate in a first way (e.g., low intensity, in a first color) when the cable puller output force, Force_{C}, is approaching the predetermined maximum force level and illuminate in a second way (e.g., high intensity, in a second color) when the cable puller output force, Force_{C}, is equal to the predetermined maximum force level. The warning message may also be an audible message. The control signal may also be used to slow down or shutdown the cable puller 10 to prevent the output force from exceeding the predetermined maximum force level. The control signal may limit the amount of power being supplied from the power supply 26 or may stop power from being supplied to the motor 42. The control signal may limit the power output of the motor 42 to reduce the force and speed applied to the capstan 22. The control signal may cause the electronic clutch 180 positioned along the transmission 18 (e.g., on the output shaft 74) to disengage and prevent torque from being transferred to the capstan 22. In some embodiments, the output force can be limited with a mechanical clutch positioned along the transmission 18 that automatically disengages when the predetermined force level is met. The user may be able to modify the spring rate of the mechanical clutch to modify the force at which the mechanical clutch disengages.

With reference to FIG. 10, the controller 28 may generate the control signal output according to the process 250 shown. The controller 28 receives a gear selection signal 255 from the gear selection sensor 114 and a signal 260 indicative of the predetermined maximum force level. A tension controller 265 determines a cable tension value 270 based on the gear selection signal 255 and based on the cable tension value 270 generates a control signal output 275. The cable tension value 270 is also provided as a cable tension feedback output 280 to the tension controller 265. In the process 250, the controller 28 relies only on the gear selection signal 255 from the gear selection sensor 114. In other embodiments, other signals may be used along with the gear selection signal 255.

The controller 28 may be operable to determine a pull range of the cable puller 10 based on the power supply 26 connected to the cable puller 10. With reference to FIG. 12, during the pulling operation the power output increases with time. Typical range estimators used in cars or lawn mowers use the instantaneous power to calculate the remaining range. Because the power output increases as more cable is being pulled, the pull range of the cable puller most be based off a predicted power rate and not the instantaneous power. Using the instantaneous power, may overestimate the range. Additionally, the power output can spike during a pulling operation (FIG. 13) when there is a bend in the conduit. To account for the bend, the pull range should be determined throughout the pulling operation.

FIG. 15 is a process 300 for determining the pull range of the cable puller 10 during a pulling operation. Before the process 300 begins, the cable puller 10 may be operated for some amount of time. For example, the cable puller 10 may be operated from time A to time B (FIG. 14). The process 300 begins with the controller 28 measuring a first instantaneous output power of the cable puller 10 (STEP 310). In FIG. 14, the first instantaneous output power is measured at time B. The first instantaneous output power may be measured or determined using the process 200, or a similar process. Then, after a predetermined amount of time has elapsed, the controller 28 measures a second instantaneous output power of the cable puller 10 (STEP 315). In FIG. 14, the second instantaneous output power is measured at time C (FIG. 14). The second instantaneous output power may be measured or determined using the process 200, or a similar process.

At STEP 320, a measured output power increase rate, based on the first instantaneous output power, the second instantaneous output power, and the predetermined amount of time, is determined by the controller 28. The measured output power increase rate, Slope₁, can be calculated as set forth below in EQN 4:

$${Slope}_{1} = ( {Power}_{c} - {Power}_{B} ) / ( {Time}_{C} - {Time}_{B} ) \qquad EQN . 4$$

where Power_{C} is the second instantaneous output power measured at time C and Power_{B} is the first instantaneous output power measured at time B. In some embodiments, the measured output power increase rate, Slope 1, may be determined using linear regression. In some embodiments, multiple measured output power increase rates may be calculated and then averaged to provide an averaged measured output power increase rate. This method may account for bends in the conduit 5. In some embodiments, the measured output power increase rate, Slope 1, may be a negative value because the capstan 22 is decreasing in speed.

Then, the amount of energy used is determined (STEP 325). The amount of energy used (E1) may be determined by comparing the amount of energy remaining (E2) in the power supply 26 to the total amount of energy of the power supply 26. The amount of energy remaining, E2, in the power supply 26 may be measured by the controller 28. The total amount of energy of the power supply 26 may be a constant that is stored in the memory 160 and is specific to the power supply 26.

Next, the future power increase rate is determined (STEP 330) based on the measured power increase rate. The future power increase rate may be similar to the measured power increase rate or may be the same as the measured power increase rate. The future power increase rate is then used to determine a remaining run time of the cable puller 10 (STEP 335). The remaining run time (e.g., the time between C and D of FIG. 14) of the cable puller 10 is determined based off the future power increase rate and a remaining amount of energy in the power supply 26. The remaining run time, Time_{CD}, of the cable puller 10 can be calculated as set forth below in EQN 5:

$${Time}_{CD} = \frac{\sqrt{{Power}_{C}^{2} + 2 ⋆ {E}_{2} ⋆ {Slope}_{2}} - {Power}_{C}}{{Slope}_{2}} \qquad EQN . 5$$

where Slope₂ is the future power increase rate of the cable puller 10 and E₂ is the remaining energy in the power supply 26. The remaining run time, Time_{CD}, may be displayed on the user interface 54. The controller 28 may generate a signal to the display when the remaining run time, Time_{CD}, is below a set amount of time (e.g., under 1 minute).

After the remaining run time, Time_{CD}, is determined, the pull range can be determined (STEP 340). The pull range, Range, can be calculated as set forth below in EQN 6:

$$Range = 2 π * {Speed}_{C} * {Radius}_{C} * {Time}_{CD} \qquad EQN . 6$$

where Speed_{C} is the speed of the capstan 22 and can be calculated as described in the process 200. In some embodiments, the capstan speed can be directly measured with a sensor. Radius_{C} is the radius of the capstan 22 and is a stored constant in the memory 160 that is specific to the capstan 22. The pull range, Range, may be displayed on the user interface 54. The controller 28 may generate a signal to the display when the pull range, Range, is below a set value (e.g., under 5 feet).

Although the process 300 of determining the pull range, Range, is described in sequential steps, it will be appreciated that some of the steps may be completed in a different order, some of the steps may be completed simultaneously, and some of the steps may be omitted.

The process 300 is used to provide a remaining time and remaining pull range during a pulling operation. The process 300 can be used in pulling operations where there are bends in the conduit 5. With reference to FIG. 16, an alternate process can be used if the conduit 5 does not include any bends. The alternate process may be less accurate than the process 300 because it does not consider any slope changes. The alternate process includes estimating the total pull time (e.g., from A to C) based on the amount of energy used during a predetermined amount of time (e.g., from A to B). The total pull time, Time_{AC}, can be calculated as set forth below in EQN 7:

$${Time}_{AC} = {Time}_{AB} * \sqrt{\frac{E 2}{E 1}} \qquad EQN . 7$$

where Time_{AB} is the amount of time the cable puller 10 has been running; E1 is the amount of energy used; and E2 is the remaining amount of energy in the power supply 26. From the total pull time, Time_{AC}, the remaining pull time, Time_{BC}, can be calculated by subtracting the amount of time the cable puller 10 has been running, Time_{AB}, from the calculated total pull time, Time_{AC}. As described in STEP 340, the remaining pull time, Time_{BC}, can be used to determine the pull range, Range.

In some embodiments, the pull calculator app 176 may be used in advanced to determine if the power supply 26 has enough energy for the planned pulling operation. The pull calculator app 176 can use information about the conduit 5 and the length of rope being pulled to determine the amount of energy needed for the planned pulling operation. The pull calculator app 176 can then determine if the attached power supply 26 can support the planned pulling operation, or if a larger power supply needs to be used. In some embodiments, the pull calculator app 176 can use previous pulls to help determine the amount of energy needed for the planned pulling operation.

Although the invention has been described in detail with reference to certain preferred embodiments, variations and modifications exist within the scope and spirit of one or more independent aspects of the invention as described.

Various features of the invention are set forth in the following claims.

1. A cable puller comprising:
a frame;
a capstan rotatably mounted on the frame;
a motor configured to drive the capstan to rotate;
a power supply configured to supply electrical current to the motor;
a transmission configured to transfer torque from the motor to the capstan, the transmission configured to operate in a low-speed configuration and a high-speed configuration, the transmission including
a first shaft configured to receive torque from the motor, the first shaft supporting a first low-speed gear, a first high-speed gear, and a shift collar configured to be selectively engaged with the first high-speed gear, and
a second shaft configured to transfer torque to the capstan, the second shaft supporting a second low-speed gear meshed with the first low-speed gear and a second high-speed gear meshed with the first high-speed gear; and
a shift assembly configured to move the shift collar between a disengaged position and an engaged position,
wherein the first low-speed gear and the second low-speed gear have a larger gear ratio than the first high-speed gear and the second high-speed gear,
wherein in the low-speed configuration, the shift collar is in the disengaged position, and
wherein in the high-speed configuration, the shift collar is in the engaged position.

2. The cable puller of claim 1, wherein the first low-speed gear is supported on the first shaft by an overrunning clutch, and wherein in the high-speed configuration, the overrunning clutch disengages the first low-speed gear from the first shaft.

3. The cable puller of claim 1, further comprising a gear position sensor configured to determine whether the transmission is in the low-speed configuration or the high-speed configuration.

4. The cable puller of claim 3, wherein the gear position sensor is a Hall-effect sensor.

5. The cable puller of claim 1, wherein the shift assembly includes a shift actuator and a lever coupled between the shift actuator and the shift collar, and activation of the shift actuator pivots the lever to move the shift collar.

6. The cable puller of claim 5, wherein the shift actuator is an electromagnetic solenoid.

7. The cable puller of claim 1, further comprising a single-stage worm gear coupled between the second shaft and the capstan and configured to prevent back driving the capstan.

8. The cable puller of claim 1, further comprising a user interface coupled to the frame and configured to indicate a condition of the cable puller.

9. The cable puller of claim 8, wherein the user interface indicates a current drawn by the motor.

10. The cable puller of claim 8, wherein the user interface indicates an estimate of a tension value of a cable being pulled by the cable puller.

11. A cable pulling system configured to pull a cable through a conduit from a feeding area to a pulling area, the system comprising:
a cable puller situated in the pulling area, the cable puller having a capstan, a motor configured to drive the capstan to rotate, a power supply configured to supply electrical current to the motor, and a controller;
a first foot pedal situated in the pulling area, the first foot pedal including a first transceiver;
a second foot pedal situated in the feeding area, the second foot pedal including a second transceiver; and
an adapter configured to electrically connect one of the first transceiver and the second transceiver to the conduit,
wherein the first transceiver and the second transceiver are configured to send a command to the controller of the cable puller.

12. The cable pulling system of claim 11, wherein the adapter is a flexible cable.

13. The cable pulling system of claim 11, wherein the adapter is a first adapter configured to electrically connect the first transceiver of the first foot pedal to the conduit, and wherein the cable pulling system further comprising a second adapter configured to electrically connect the second transceiver of the second foot pedal to the conduit.

14. A method of determining an output force of a cable puller having a capstan, a motor configured to rotate the capstan, a transmission configured to transmit torque from the motor to the capstan, a power supply configured to supply electrical current to the motor, and a controller, the method comprising:
determining a power output of the motor;
detecting a configuration of the transmission;
determining a gear ratio based on the configuration of the transmission;
determining a speed of the capstan based on a speed of the motor and the gear ratio;
determining a torque of the capstan based on the power output of the motor and the speed of the capstan; and
determining the output force of the cable puller using the torque of the capstan and a radius of the capstan.

15. The method of claim 14, further comprising limiting the output force of the cable puller if the output force of the cable puller exceeds a predetermined output force level.

16. The method of claim 15, wherein limiting the output force of the cable puller includes reducing the power output of the motor.

17. The method of claim 15, wherein the transmission includes a disengagement clutch, and wherein limiting the output force of the cable puller includes disengaging the disengagement clutch such that the transmission cannot transfer torque to the capstan.

18. The method of claim 15, further comprising setting the predetermined output force level based on a user selected output force limit.

19. The method of claim 14, wherein the transmission includes a collar moveable between an engaged position and a disengaged position, and wherein detecting the configuration of the transmission includes sensing if the collar is in the engaged position or if the collar is in the disengaged position with a sensor.

20. The method of claim 19, wherein the sensor is a Hall-effect sensor, and wherein sensing a position of the collar includes detecting a presence of a magnet positioned on the collar with the Hall-effect sensor.

21.-28. (canceled)
